(19) United States
(12) Patent Application Publication
(10) Pub. No.: US 2016/0186290 A1
(43) Pub. Date: Jun. 30, 2016

(54) METALLURGICAL SLAG COATINGS FOR REFRACTORY SUBSTRATES

(71) Applicant: Comanche Technologies, LLC, Downingtown, PA (US)

(72) Inventors: Jay R. Hitchings, Downingtown, PA (US); Jason Hitchings, Downingtown, PA (US)

(21) Appl. No.: 15/063,226

(22) Filed: Mar. 7, 2016

Related U.S. Application Data
(63) Continuation-in-part of application No. 13/112,865, filed on May 20, 2011, now Pat. No. 9,315,426.
(60) Provisional application No. 61/346,513, filed on May 20, 2010.
(60) Provisional application No. 62/129,286, filed on Mar. 6, 2015.

(51) Int. Cl. C22B 9/02; F27D 15/00; C21B 3/04

(52) U.S. Cl. CPC C22B 9/023; C21B 3/04; F27D 15/00

(57) ABSTRACT

Coatings comprising metallurgical slag are applied to refractory substrates having molten metal-contacting surfaces to create a chemically active and viscous surface that dramatically increases the ability of the treated substrate to remove slag, dross and other inclusions from a base metal alloy as it passes through or contacts the substrate. The refractory substrates include molten metal filters used by foundries and metal casters such as reticulated ceramic foam, cellular/honeycomb, silica mesh, and others that rely on their physical or sieving ability to remove particulate impurities from the base alloy being cast. The chemically active surfaces significantly increase filtration efficiency through a treatment process tailored to the specific chemistry of the alloy being filtered, such as ferrous metals that include iron, steel and more. Other refractory substrates such as aluminum oxide, magnesium oxide, zirconium oxide, aluminum silicate, silicon carbide (as common with reticulated ceramic foam filters) and the like may also include the coatings.

### CROSS-REFERENCE TO RELATED APPLICATIONS

This application is a continuation-in-part of U.S. patent application Ser. No. 13/112,865 filed May 20, 2011, which claims the benefit of U.S. Provisional Patent Application Ser. No. 61/346,513 filed May 20, 2010. This application also claims the benefit of U.S. Provisional Patent Application Ser. No. 62/129,286 filed Mar. 6, 2015. All of these applications are incorporated herein by reference.

### FIELD OF THE INVENTION

The present invention relates to metallurgical slag coatings for refractory substrates, and more particularly relates to active coatings for refractory filters and other substrates that help remove inclusions and other impurities from molten metals such as ferrous alloys.

### BACKGROUND INFORMATION

The effective removal of slag, dross and other potentially harmful inclusions from molten metal during the casting process has conventionally relied on a wide spectrum of molten metal filters that capture the impurities by physical means. For example, reticulated ceramic foam filters utilize a torturous path principle whereby as the molten metal is forced to travel through the random nooks and crannies of the filter, many of the particulate inclusions are trapped within interior cavities and passages. In a similar manner, cellular or honeycomb molten metal filters act as sieves or screens that catch large particle inclusions that are too large to pass through the pore openings of the filters.

While screen-based filtration techniques have been widely used, they are ineffective in capturing small inclusions that pass through the pores of the filters. Furthermore, they are structurally unable to increase the molten metal throughput without a corresponding decrease in filtration efficiency. Smaller size inclusions continue to be a problem for foundries and metal casters despite the widespread use of sieving filters. Such inclusions can be detrimental in various castings, particularly castings used in aerospace and other demanding applications. Similarly, while most metal casting producers may desire increases in molten metal throughput per production run, very few are willing to accept the higher potential scrap rate that could occur in switching to larger pore size molten metal filters which would in turn allow additional inclusions to pass through.

Phenolic-resin treated silica mesh filter cloths have also been used to remove inclusions from cast iron. As the molten iron comes in contact with the resin-treated silica cloth, pyrolysis of the resin takes place, creating Fe₂SiO₄ that coats the fabric and increases the ability of the filter cloth to capture inclusions. The iron silicate provides a sticky surface that captures and holds slag particulates that are small enough to pass through the mesh holes of the material, and thereby increases the overall efficiency of the filter. Iron silicate also has the ability to form solid solutions with some of the specific impurities unique to different types of cast iron. However, the formation of the iron silicate occurs during the molten ferrous alloy casting process and requires the use of a silica-containing filter in combination with the ferrous alloy. It would be desirable to improve filtration capability by providing controlled amounts of active coatings on various different types of molten metal filters such as reticulated ceramic foam, cellular/honeycomb and the like.

U.S. patent application Ser. No. 13/112,865 discloses coatings for refractory substrates comprising metallurgical slag and a silicate binder.

### SUMMARY OF THE INVENTION

The present invention provides coatings comprising metallurgical slag including iron silicon oxide active components applied to refractory substrates having molten metal-contacting surfaces. The coatings create chemically active and viscous surfaces that significantly increase the ability of the treated substrate to remove slag, dross and other inclusions from a base metal alloy as it passes through or contacts the substrate. The refractory substrates include molten metal filters used by foundries and metal casters such as reticulated ceramic foam, cellular/honeycomb, silica mesh and the like that rely on their physical or sieving ability to remove particulate impurities from the base alloy being cast. The chemically active surfaces significantly increase filtration efficiency through a treatment process tailored to the specific chemistry of the alloy being filtered, such as ferrous metals. In addition to silica, other refractory substrates such as aluminum oxide, magnesium oxide, zirconium oxide, aluminum silicate and silicon carbide may be treated with the coatings of the present invention.

An aspect of the present invention is to provide a coated refractory substrate capable of withstanding exposure to molten metal comprising: a refractory substrate; and a coating on at least a portion of the substrate comprising a metallurgical slag comprising an iron silicon oxide active component.

A further aspect of the present invention is to provide a method of coating a refractory substrate comprising depositing a coating on at least a portion of the substrate comprising a metallurgical slag comprising an iron silicon oxide active component.

Another aspect of the present invention is to provide a method of filtering molten metal comprising passing molten metal through a filter comprising a refractory substrate comprising a coating including a metallurgical slag comprising an iron silicon oxide active component.

These and other aspects of the present invention will be more apparent from the following description.

### DETAILED DESCRIPTION

The present invention provides metallurgical slag coatings for refractory substrates that improve their ability to remove inclusions and other impurities from metal castings. In certain embodiments, the metallurgical slag coatings include an iron silicon oxide active component and are applied to molten metal filters to convert from a strictly physical filtration process to an active process for removing inclusions and other impurities from molten alloys. The coated filters can capture significantly more inclusions than conventional filters with no significant changes or modifications required in the casting mold pattern, process or other end-user application parameters. Furthermore, metal casters desiring an increased throughput rate will have less reduction in total filter efficiency when switching to a larger pore-size, due to the chemical filtration capability of the present coated filters.

A wide variety of ceramic-type and other molten metal filters may be coated in accordance with the present invention, including reticulated ceramic foam, pressed ceramic, ceramic honeycomb, silica mesh, fiberglass mesh, ceramic coated silica mesh, ceramic coated fiberglass mesh, and extruded lattice type filters. The coatings produce beneficial by-product reactions that enhance inclusion removal and promote higher quality end castings as the molten metal passes through the coated filter material.

In addition to filters, the present coatings may be applied to other refractory substrates. For example, the coatings may be applied to the interior surface of ceramic pour cones used in investment casting, the interior surface of riser sleeves, and the inner linings of pouring or holding ladles, skimmers, fittings, and the like. In each of these applications, the material surface that contacts the molten alloy can be treated with the present coatings. The active component of the coating may react by absorbing harmful alloy-specific reaction byproducts, e.g., by forming into a solid solution that holds the byproducts to the surface of the treated vessel or material.

In accordance with the present invention, a metallurgical slag coating is applied on at least a portion of a refractory substrate. The metallurgical slag may include an iron silicon oxide active component and, optionally, a binder. The iron silicon oxide active component may include Fe₂SiO₄, Fe₂O₃, FeO, SiO₂ or a combination thereof. For example, the iron silicon oxide active component may comprise Fe₂O₃ and/or FeO and SiO₂. In another embodiment, the iron silicon oxide active component comprises Fayalite (Fe₂SiO₄). Fayalite is present in certain metallurgical slags, for example, in large scale metallurgical smelting operations where Fayalite is a discarded byproduct. The material has a melting point of about 2,223° F. (1,210° C.) and is a part of the Olivine group of minerals. Within the Olivine group, it can be found in both the Fayalite-Forsterite series and the Fayalite-Tephroite series. The metallurgical slag may be produced as byproducts of various iron and steel-making processes. Altneratively, metallurgical slags may be produced during non-ferrous metallurgical processes. The metallurgical slag may comprise additional oxides such as Al₂O₃, CaO, ZnO and/or MgO.

The iron silicon oxide-containing metallurgical slag may be provided in granular form having an average particle size range of from about 10 to about 10,000 microns, for example, from about 30 to about 3,500 microns. To ensure a uniform coating, it is desirable to control the particle size of the iron silicon oxide. The particular particle size utilized may depend on the pore size and specific morphology of the filter to be coated. Filters with smaller pore sizes tend to require a finer consistency and vice versa.

In accordance with certain embodiments of the present invention, a bonding agent is used to enable the metallurgical slag particles to adhere to the surface of the ceramic filter. The use of a binder provides a secure and stable bond between the surface of the refractory substrate and the coating before and after melting. The binder may help to bond the iron silicon oxide active component to the refractory substrate prior to exposure to molten metal. Suitable binders include silica, phenolic resin, polymers, sugar, molasses, and the like. The metallurgical slag comprising iron silicon oxide typically comprises from 20 to 100 weight percent of the coating, while the binder typically comprises from zero to about 80 weight percent. For example, when a binder is used, the iron silicon oxide may comprise from 40 to 99 weight percent, and the binder may comprise from 1 to 60 weight percent. In certain embodiments, the iron silicon oxide may comprise from 50 to 95 weight percent, and the binder may comprise from 5 to 50 weight percent.

An embodiment of the present invention utilizes a silica-containing binder, such as a colloidal silica binder comprising silica suspended or dispersed in water. Silica may be present in a typical amount of from 15 to 50 weight percent, or from 25 to 40 weight percent, with the balance comprising water and minor amounts of additives, such as sodium hydroxide (e.g., less than 0.6 weight percent) and a mixture of 5-chloro-2-methyl-4-isothiazolin-3-one and 2-methyl-2H-isothiazol-3-one (e.g., less than 0.003 percent). Using this technique, a refractory substrate can be thinly coated with the colloidal silica binder with the granular metallurgical slag particles placed onto the target surface while the ceramic slurry is still wet. After the colloidal silica binder coating dries, the granular metallurgical slag particles are embedded directly into it and are partially exposed. In this manner, the ceramic slurry acts as an effective bonding agent between the refractory substrate and the granular metallurgical slag. The granular metallurgical slag may also be mixed into the colloidal silica binder aqueous suspension directly for a complete coating of the refractory substrate, in addition to the partially exposed coating on the incoming molten metal face of the refractory substrate surface.

Another embodiment of the present invention uses a phenolic or polymer based resin as the primary binding agent. Phenol-formaldehyde based resins include novolacs and resoles, and are conventionally used in metalcasting and foundry applications for a wide variety of applications, primarily as a molding sand additive. In accordance with this embodiment, a phenolic resin is used as a high heat tolerant binding agent to secure granular metallurgical slag to a refractory substrate is a novel concept. Similar to the previously described embodiment, a thin coating of a phenolic or polymer resin is applied to the target refractory substrate, followed by an even disbursement of the granular metallurgical slag on top of the coating. A phenolic or polymer resin treated refractory substrate may be set aside to air-dry on its own or may be subject to a variety of heat-curing techniques to achieve the desired fully-cured end state. Suitable phenolic and polymer based resins include commercially available resins used in the foundry and metalcasting industry as sand-mold binding agents.

A further embodiment of the present invention uses a carbohydrate such as sugar, molasses starch or the like as the primary binding agent. Water is typically used to dilute the concentration. Similar to the previously described embodiments, a thin coating of, e.g., a sugar or molasses based aqueous solution, is applied to the target refractory substrate, followed by an even disbursement of the granular metallurgical slag on top of the coating. The sugar or molasses based aqueous solution treated refractory substrate may be set aside to air-dry on its own or may be subject to a variety of heat-curing techniques to achieve the desired fully-cured end state.

In an embodiment of the present invention, the binder is applied to the refractory substrate separately from the metallurgical slag. For example, the binder may be applied as a first layer on at least a portion of the refractory substrate, followed by application of the granular metallurgical slag. The face of the filter being treated may be coated with a binder solution, followed by an application of granular metallurgical slag across the coated surface area and into at least a portion of the pore openings of the filter. The first layer comprising the binder may thus contact the refractory substrate directly, while the metallurgical slag particles form a second layer covering the first binder layer. The bonding agents hold the granular metallurgical slag particles securely to the surface. In this embodiment, the first binder layer may have a typical thickness of from about 10 to about 200 microns, for example, from about 25 to about 130 microns. The second layer comprising metallurgical slag may have a typical thickness of from about 200 to about 1,000 microns, for example, from about 300 to about 500 microns.

In another embodiment of the present invention, the metallurgical slag and binder may be applied to the refractory substrate together, for example, in liquid or paste form as an aqueous suspension of the iron silicon oxide particles and binder compounds. The applied coating may thus comprise both the iron silicon oxide particles and binder in the same layer.

An additional embodiment of the present invention bypasses the use of a binding agent and instead employs a high temperature flash-melting application technique of the granular metallurgical slag directly to the target refractory substrate. The granular metallurgical slag is placed on the surface of the target refractory substrate, and then subjected to high heat for a short time period in order to flash-melt the metallurgical slag directly onto the surface of the refractory substrate. An example of this technique would be the use of high temperature thermal spraying equipment to evenly coat a target refractory substrate with a molten or semi-molten spray of metallurgical slag, followed by a short cooling period where the melted metallurgical slag coating hardens on the surface of the refractory substrate. Any suitable type of thermal spray device known to those skilled in the art may be used, such as flame spray systems, plasma spray systems and the like.

A further embodiment of the present invention uses an application technique that applies an even coating of the granular metallurgical slag directly to the refractory substrate while the refractory substrate material is still in the semi-soft or green state of its own manufacturing process. This embodiment provides a direct-bond between the granular metallurgical slag and the refractory substrate itself. The manufacturing process used for creating most ceramic filters and other refractory substrates designed for direct contact with molten alloys requires that they first be shaped (pressed or extruded) into the desired dimension, and then heated or fired at a high temperature in order to “cure” the refractory substrate. This second technique involves the placement of the granular metallurgical slag onto the still “wet” or “green” surface of the target refractory substrate prior to this final heating/firing/curing step. Once the granular metallurgical slag is placed onto the surface of the refractory substrate, the refractory substrate is then subjected to the final step of heating/firing/curing at high temperature. During this final phase, the granular metallurgical slag will melt and or adhere directly to the surface of the refractory substrate. In this manner, a direct-bond is created between the granular metallurgical slag and the target refractory substrate. Although the specific fabrication and processing techniques for refractories can vary greatly based on their intended end-use, most ceramic filters, ladles, pour cones and kiln furniture have an intermediary production state where the refractory ceramic material is not yet fully-cured and remains semi-soft. This state is typically referred to as green, with the next and final processing step being firing or heat-curing of the refractory to the point where it becomes fully hardened and all moisture is baked away. This embodiment involves the direct and even disbursement of granular metallurgical slag across the surface of the target refractory during the green state phase of the overall refractory substrate production process. In this manner, the granular metallurgical slag will partially embed itself directly into the semi-soft or green refractory substrate surface, but still remain exposed enough after full heat curing to react with molten metal and perform its role in improving molten metal filtration via the creation of a sticky surface that captures slag and other inclusions. As the refractory moves into the final processing phase of full heat-curing, the semi-soft refractory material will harden and firmly secure the granular metallurgical slag to its surface.

The coated filters may be placed into any variety of molding setups or investment casting pour cones, and provide filtration through both physical sieving and the chemical activity of the coating. Reactions occur upon contact of the molten alloy with the surface of the filter. For example, the iron content of the iron silicon oxide active component may be reduced to form certain reaction byproducts specific to the cast ferrous alloy. As a particular example, when molten ductile iron makes contact with the iron silicon oxide component of the coating, the iron component within the iron silicon oxide may be replaced by magnesium reaction products, which transforms the coating into spinel-like compounds having very high melting points. In the case of gray iron, the iron of the iron silicon oxide may be replaced by manganese silicates and oxides. In either case, the chemistry of the iron silicon oxide coating changes upon contact with the cast ferrous alloy. At the same time this conversion is taking place, the heat of the molten alloy melts the granular iron silicon oxide and may spread the coating across the surface face and into the pores of the filter interior. During this contact reaction, the viscous and sticky surfaces created by the iron silicon oxide help capture and entrap endogenous and exogenous slag and inclusions, both large and small, on the surface face and within the pores or interior channels of the filter. Without this surface-active coating, the smaller particulate inclusions can pass through the pores and holes of the filter, and could eventually end up in the casting itself.

In accordance with an embodiment of the invention, the composition of the iron silicon oxide surface-active coating may be selected based upon the chemistry of the possible inclusions or slag/dross unique to the alloy being cast. In the case of ferrous alloys, inclusions such as magnesium reaction products found in ductile iron or manganese silicates and oxides common to gray iron may be removed by reaction with the active coating to form solid solutions that are subsequently held in place on the filter surface. Without the sticky filter surface, the inclusions can pass through the pores and interior of the filter and onward through the runner system and end-casting. Examples of problematic inclusions associated with ferrous alloys include Tephroite and Forsterite. Tephroite is a manganese silicate (Mn₂SiO₄) known to cause blow-hole cavities and other porosity related defects in gray iron castings. Forsterite is another magnesium silicate (Mg₂SiO₄) that frequently causes cell boundary inclusions in the casting microstructure that weaken structural integrity.

A chemical analysis of a metallurgical slag comprising an iron silicon oxide material is shown in Table 1. However, the amounts of iron oxides, silicon dioxide and other oxides may be adjusted as desired.

TABLE 1

| Component | Weight % of Total |
|---|---|
| Fe₂O₃ + FeO | 57% |
| SiO₂ | 29.5% |
| Al₂O₃ | 5% |
| CaO | 3.5% |
| ZnO | 2.5% |
| MgO | 1% |

The following examples illustrate various aspects of the present invention, and are not intended to limit the scope of the invention.

### Example 1

A commercially available colloidal silica binder sold under the designation LUDOX HS-40 by Sigma-Aldrich Corporation is used as a binding agent in securing granular metallurgical slag to the surface of a target refractory substrate. The grade of colloidal silica binder may be deionized to remove sodium with an approximate content weight of 34% silica (SiO₂) suspended in water and has a pH range of 4-9. The target refractory substrate in this example is a 2×2×0.5 inch thick reticulated ceramic foam filter made of zirconia refractory with a pore size of 10 pores per inch. This filter is first placed into a bowl filled with the colloidal silica binder solution and submerged completely. After a few seconds, the filter is then lifted out and placed on a wire mesh rack to drain off the excess colloidal silica binder solution. Next, an even application of granular metallurgical slag particles (+60/−200 mesh range) is sprinkled over the top surface and upper interior of the filter. The filter is then turned over so that the bottom surface and lower interior of the filter can also be evenly coated with the same granular metallurgical slag particles. The coated filter is next gently blown with heated air (approximately 214° F.) to remove excess or loose granular metallurgical slag particles that might block any of the filter pores and then placed on a rack within a curing oven set at 597° F. for approximately 10 minutes. This final heat-curing step drives out any residual moisture and securely binds the granular metallurgical slag particles to the zirconia filter refractory substrate.

### Example 2

In this example, a bowl is filled with an undiluted commercial grade novolac resin. The target refractory substrate, a silicon carbide reticulated ceramic foam filter having a 2.5 inch diameter and 0.76 inch thickness with a pore size of 10 pores per inch, is placed into the bowl of phenolic resin and fully submerged. After a few seconds, the filter is removed from the bowl and placed upon a wire rack to drain off the excess phenolic resin liquid. Next, an even application of granular metallurgical slag particles (+60/−200 mesh range) is sprinkled over the top surface and upper interior of the filter. The filter is then turned over so that the bottom surface and lower interior of the filter can also be evenly coated with the same granular metallurgical slag particles. The coated filter is next gently blown with heated air (approximately 216° F.) to remove excess or loose granular metallurgical slag particles that might block any of the filter pores and then placed on a rack within a curing oven set at 600° F. for approximately 12 minutes. This final heat-curing step drives out most of the moisture from the phenolic resin as it sets, and firmly binds the granular metallurgical slag to the surfaces of the silicon carbide reticulated ceramic foam filter. The filter is then removed from the oven and set on a rack to cool.

### Example 3

A general purpose acrylic polymer emulsion is selected for use as a binding agent to secure the granular metallurgical slag to another commonly used molten metal filter type, in this case a 3×3×0.5 inch thick pressed cellular filter made of mullite with a cell hole size of 0.15 inch. A bowl is filled with an undiluted emulsion of acrylic polymer, then the mullite filter is gently placed into the bowl and fully submerged. After a few seconds, the filter is removed from the bowl and placed upon a wire rack to drain off the excess acrylic polymer emulsion. Next, an even application of granular metallurgical slag particles (+60/−200 mesh range) is sprinkled over the top surface and upper interior of the filter. The filter is then turned over so that the bottom surface and lower interior of the filter can also be evenly coated with the same granular metallurgical slag particles. The coated filter is next gently blown with heated air (approximately 216° F.) to remove excess or loose granular metallurgical slag particles that might block any of the filter cell-holes and then placed on a rack within a curing oven set at 600° F. for approximately 10 minutes. Afterward, the filter is placed on a rack to cool.

### Example 4

A sugar-based binding agent is used to secure granular metallurgical slag to a refractory substrate. This example utilizes an aqueous solution of lignin (11.89 grams / 72.5%) and carbohydrate (4.5 grams / 27.4%), which is poured into a bowl at room temperature. The target refractory substrate is a silicon carbide reticulated ceramic foam filter having a 2.5 inch diameter and 0.76 inch thickness with a pore size of 10 pores per inch, which is placed into the bowl of sugar-based adhesive solution and moved around gently until fully coated inside and out. Next, the filter is removed from the bowl and placed upon a wire rack to drain off the excess sugar-based adhesive solution. Then, an even application of granular metallurgical slag particles (+60/−200 mesh range) is sprinkled over the top surface and upper interior of the filter. The filter is then turned over so that the bottom surface and lower interior of the filter can also be evenly coated with the same granular metallurgical slag particles. The coated filter is next gently blown with directed air (room temperature) to remove excess or loose granular metallurgical slag particles that might block any of the filter pores and then placed on a rack within a curing oven set at 375° F. for approximately 15 minutes. This final heat curing of the filter purges all remaining moisture from the sugar-based binding agent and firmly secures the granular metallurgical slag particles to the coated surfaces and interior of the silicon carbide reticulated ceramic foam filter substrate.

### Example 5

This example bypasses the use of a liquid binding agent and instead utilizes a direct-bonding technique whereby the granular metallurgical slag particles are evenly applied across the surface-face of the target refractory substrate by flash-melting them with a thermal spray application. The target refractories in this example are four individual pressed cellular filters made of mullite, each measuring 3×3×0.5 inch thick, with a cell hole size of 0.15 inch. The filters are placed on a wire mesh conveyor belt set to index slowly underneath of a thermal spray jet head that is fed from a media hopper filled with the granular metallurgical slag particles (+60/−200 mesh range). Next, the conveyor belt slowly indexes each filter underneath the thermal spray head and an even coating of the molten metallurgical slag (semi and fully molten particles) is sprayed across the surface and upper interior of each filter. As the last of the four filters passes underneath the thermal spray applicator head, the first filter is removed and turned over for placement on the conveyor belt at the front end so that it does go through for a second pass to coat the opposite side of the filter. This is repeated for each of the remaining filters, with all ending up evenly coated after the second pass is complete. The coated filters are left on the conveyor belt to cool at room temperature for 10 minutes.

### Example 6

Pressed ceramic cellular mullite filters measuring 3×3×0.5 inch thick with a cell hole size of 0.15 inch are coated as follows. A vibratory shaker disbursement ladle is fitted to a feeder-hopper filled with a small quantity of granular metallurgical slag particles (+60/−200 mesh range) located approximately six inches above a slowly moving conveyor belt covered by a single line of the mullite filters while just entering the transitory green state of processing. As the conveyor belt moves the filters along slowly underneath the gently vibrating disbursement ladle above, a controlled rain of granular metallurgical slag particles randomly coats the surface face of each mullite filter as it passes below. The test is set to coat a total of eight filters, and when the conveyor belt reaches the midpoint of the line of filters, the first few that pass through coating are removed by hand, turned over, and placed back on the conveyor belt at the starting end to run underneath the vibratory disbursement ladle for a second pass to coat the opposite side. Once all the filters have gone through the second pass and are fully coated, they are transferred to a large wire oven rack and placed inside a primary curing kiln for final process baking. This last curing step purges all residual moisture from the mullite refractory and the ceramic hardens fully to firmly secure the granular metallurgical slag particles on the outer surfaces and mid-way into the interior of the filter bodies.

Whereas particular embodiments of this invention have been described above for purposes of illustration, it will be evident to those skilled in the art that numerous variations of the details of the present invention may be made without departing from the invention as defined in the appended claims.

1. A coated refractory substrate capable of withstanding exposure to molten metal comprising:
a refractory substrate; and
a coating on at least a portion of the substrate comprising a metallurgical slag comprising an iron silicon oxide active component.

2. The coated refractory substrate of claim 1, wherein the iron silicon oxide active component comprises Fe₂SiO₄, Fe₂O₃, FeO, SiO₂ or a combination thereof.

3. The coated refractory substrate of claim 1, wherein the iron silicon oxide active component comprises Fe₂O₃, FeO and SiO₂.

4. The coated refractory substrate of claim 1, wherein the iron silicon oxide active component comprises at least one additional oxide selected from Al₂O₃, CaO, ZnO and MgO.

5. The coated refractory substrate of claim 1, wherein the metallurgical slag has an average particle size range of from about 30 to about 3,500 microns.

6. The coated refractory substrate of claim 1, wherein the coating further comprises a binder.

7. The coated refractory substrate of claim 6, wherein the coating comprises a first layer comprising the binder and a second layer comprising the metallurgical slag.

8. The coated refractory substrate of claim 7, wherein the first layer contacts the refractory substrate and the second layer covers at least a portion of the first layer.

9. The coated refractory substrate of claim 8, wherein the second layer covers substantially all of the first layer.

10. The coated refractory substrate of claim 7, wherein the first layer has a thickness of from about 25 to about 130 microns, and the second layer has a thickness of from about 300 to about 500 microns.

11. The coated refractory substrate of claim 6, wherein the metallurgical slag comprises from about 20 to about 99 weight percent of the coating and the binder comprises from about 1 to about 80 weight percent of the coating.

12. The coated refractory substrate of claim 6, wherein the binder comprises silica.

13. The coated refractory substrate of claim 6, wherein the binder comprises a phenolic resin.

14. The coated refractory substrate of claim 6, wherein the binder comprises sugar or molasses.

15. The coated refractory substrate of claim 1, wherein the coating is deposited directly on the refractory substrate.

16. The coated refractory substrate of claim 15, wherein the coating is thermally sprayed.

17. The coated refractory substrate of claim 15, wherein the coating is deposited on an uncured refractory substrate that is subsequently cured.

18. The coated refractory substrate of claim 1, wherein the refractory substrate comprises at least one ceramic selected from silica, aluminum oxide, magnesium oxide, zirconium oxide, aluminum silicate and silicon carbide.

19. The coated refractory substrate of claim 1, wherein the refractory substrate comprises a reticulated ceramic foam filter, a cellular honeycomb structure filter, a ceramic coated silica mesh filter, a ceramic coated fiberglass mesh filter, a silica mesh filter, a fiberglass mesh filter, a ceramic coated steel wire mesh filter, a steel wire mesh filter or an extruded ceramic lattice filter.

20. A method of coating a refractory substrate comprising depositing a coating on at least a portion of the substrate comprising a metallurgical slag comprising an iron silicon oxide active component.

21. A method of filtering molten metal comprising passing molten metal through a filter comprising a refractory substrate comprising a coating including a metallurgical slag comprising an iron silicon oxide active component.
